(19) United States
(12) Patent Application Publication
(10) Pub. No.: US 2007/0207275 A1
(43) Pub. Date: Sep. 6, 2007

(54) Enhancement of remote plasma source clean for dielectric films

(75) Inventors: Thomas Nowak, Cupertino, CA (US); Kang Sub Yim, Santa Clara, CA (US); Sum-Yee Betty Tang, San Jose, CA (US); Kwangduk Douglas Lee, Santa Clara, CA (US); Vu Ngoc Tran Nguyen, Santa Clara, CA (US); Dennis Singleton, San Jose, CA (US); Martin Jay Seamons, San Jose, CA (US); Karthik Janakiraman, San Jose, CA (US); Ganesh Balasubramanian, Sunnyvale, CA (US); Mohamed Ayoub, San Jose, CA (US); Wendy H. Yeh, Mountain View, CA (US); Alexandros T. Demos, Fremont, CA (US); Hichem M'Saad, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/508,544

(22) Filed: Aug. 23, 2006

Related U.S. Application Data
(60) Provisional application No. 60/775,414, filed on Feb. 21, 2006.

(51) Int. Cl. H05H 1/24

(52) U.S. Cl. 427/569

(57) ABSTRACT

Methods for cleaning semiconductor processing chambers used to process carbon-containing films, such as amorphous carbon films, barrier films comprising silicon and carbon, and low dielectric constant films including silicon, oxygen, and carbon are provided. The methods include using a remote plasma source to generate reactive species that clean interior surfaces of a processing chamber in the absence of RF power in the chamber. The reactive species are generated from an oxygen-containing gas, such as O₂, and/or a halogen-containing gas, such as NF₃. An oxygen-based ashing process may also be used to remove carbon deposits from the interior surfaces of the chamber before the chamber is exposed to the reactive species from the remote plasma source.

### CROSS-REFERENCE TO RELATED APPLICATIONS

This application claims the benefit under 35 U.S.C. § 119(e) to provisional application No. 60/775,414, filed Feb. 21, 2006, the entire contents of which are incorporated herein by reference.

### BACKGROUND OF THE INVENTION

1. Field of the Invention

Embodiments of the present invention generally relate to methods of cleaning a processing chamber using a remote plasma source.

2. Description of the Related Art

Integrated circuit geometries have dramatically decreased in size since such devices were first introduced several decades ago. Since then, integrated circuits have generally followed the two year/half-size rule (often called Moore's Law), which means that the number of devices on a chip doubles every two years. Today's fabrication facilities are routinely producing devices having 0.13 μm and even 0.1 μm feature sizes, and tomorrow's facilities soon will be producing devices having even smaller feature sizes.

One of the developments that has facilitated such small device sizes is the development of patterning films that are capable of being finely patterned and that have the ability to transfer fine patterns through underlying layers of a substrate. An example of such patterning films are amorphous carbon films, such as APF™films, available from Applied Materials, Inc. of Santa Clara, Calif.

The use of amorphous carbon patterning films in semiconductor device fabrication has generated a need for a method of removing carbon-containing material that is undesirably deposited on interior surfaces, such as the sidewalls and chamber components, of chambers used to process, e.g., deposit or etch, the amorphous carbon patterning films. Cleaning processes that use oxygen (O₂) as a cleaning gas activated by in situ radio frequency (RF) power in the chamber have been developed for cleaning chambers used to deposit amorphous carbon films. However, the in situ RF power required to remove the carbon-containing deposits can damage chamber components. Cleaning processes that use O₂ as a cleaning gas activated by a remote plasma source can reduce or eliminate chamber damage during the cleaning process. However, many of the oxygen radicals generated by the remote plasma source recombine before sufficient chamber cleaning is achieved. For example, the oxygen radicals may recombine to form O₂ before they reach all regions of the chamber that require cleaning.

The continued reduction in device geometries has also generated a demand for films having lower dielectric constant (k) values. Low dielectric constant films such as organosilicon films (SiCOH films) having k values less than about 3.0 and even less than about 2.5 have been developed. The films have a high carbon content. Low dielectric constant SiCOH films are often used in conjunction with silicon and carbon-containing barrier films.

The development of low dielectric constant films having a high carbon content has generated a need for a method of removing carbon-containing material that is deposited on interior surfaces of chambers used to process the low dielectric constant films. It has been found that methods that have been used to remove material originating from other dielectric films, such as non-carbon-containing silicon oxide films, may have undesirable side effects and are not always sufficient to remove the carbon from deposits originating from low dielectric constant films having a high carbon content. For example, it has been observed that cleaning a low dielectric constant organosilicon film deposition chamber by providing in situ radio frequency (RF) power to the chamber to activate sufficient NF₃ to clean carbon deposits can result in the formation of contaminating aluminum fluoride particles, since the fluorine ions generated by the RF power can combine with aluminum, which is often used as a lining material in processing chambers.

The removal of contaminating particles from a processing chamber is becoming increasingly important because the device sizes are becoming smaller and aspect ratios are becoming more aggressive. With smaller feature sizes and more aggressive aspect ratios, the size and number of contaminating particles must be minimized in order to maintain the performance of the device.

Therefore, there remains a need for a method of cleaning processing chambers efficiently, while minimizing contaminant generation. In particular, there remains a need for a method of cleaning chambers used to process films having a high carbon content, such as amorphous carbon films that may be used as patterning films, low dielectric constant organosilicon films, and silicon and carbon-containing barrier films.

### SUMMARY OF THE INVENTION

The present invention generally relates to methods of cleaning semiconductor processing chambers. Semiconductor processing chambers used to process films comprising carbon and having carbon-containing deposits on their interior surfaces can be cleaned using the methods described herein. For example, semiconductor processing chambers used to process amorphous carbon films, barrier films comprising silicon and carbon, and low dielectric constant films comprising silicon, oxygen, and carbon can be cleaned using the methods described herein.

In one embodiment, a method of cleaning a processing chamber having carbon-containing deposits comprises generating reactive oxygen species from an oxygen-containing gas in a remote plasma source connected to the processing chamber, generating reactive nitrogen species from a nitrogen-containing gas in the remote plasma source, introducing the reactive oxygen species and the reactive nitrogen species into the processing chamber, and exposing interior surfaces of the processing chamber to the reactive oxygen species and the reactive nitrogen species in the absence of RF power in the chamber. The chamber has a gas distribution assembly comprising a faceplate and chamber walls that are both heated to a temperature, preferably of at least 150° C., during the cleaning process. Reactive fluorine species may also be introduced from the remote plasma source into processing chambers used to deposit films comprising silicon and carbon, while processing chambers used to deposit non-silicon containing films can be cleaned without using reactive fluorine species.

In another embodiment, a method of cleaning a processing chamber comprises performing an oxygen-based ashing process in the processing chamber, generating reactive species from a halogen-containing gas in a remote plasma source connected to the processing chamber, introducing the reactive species from the halogen-containing gas into the processing chamber, and exposing interior surfaces of the processing chamber to the reactive species.

The oxygen-based ashing process includes introducing an oxygen-containing gas into the processing chamber and applying RF power in the processing chamber to generate reactive oxygen species from the oxygen-containing gas. The oxygen-based ashing process may be performed as one step. Alternatively, the oxygen-based ashing process may be performed in two steps, with one step for cleaning a faceplate of the processing chamber and another step for cleaning other interior surfaces of the processing chamber. The RF power in the processing chamber is terminated after the oxygen-based ashing process, and the interior surfaces of the processing chamber are exposed to the reactive species from the remote plasma source in the absence of RF power. The oxygen-based ashing process may be used to remove carbon-containing deposits from interior surfaces of the chamber, and the reactive species from the remote plasma source may be used to subsequently remove silicon and oxygen-containing deposits from the interior surfaces of the chamber. In a preferred embodiment, the oxygen-containing gas used in the oxygen-based ashing process is oxygen (O₂), and the halogen-containing gas that provides the reactive species in the remote plasma source is nitrogen trifluoride (NF₃).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart summarizing an embodiment of a method of cleaning a processing chamber.

FIG. 2 is a cross-sectional view of a processing chamber that may be cleaned according to embodiments of the invention.

FIG. 3 is a flow chart summarizing another embodiment of a method of cleaning a processing chamber.

FIG. 4 shows the Si—CH₃ profile of FTIR spectra of interior chamber surfaces over the course of an oxygen-based ashing process performed according to an embodiment of the invention.

### DETAILED DESCRIPTION

The present invention generally provides methods for cleaning processing chambers, e.g., deposition chambers, used in the fabrication of integrated circuits and semiconductor devices. The cleaning methods include using reactive species generated in a remote plasma source to clean carbon-containing deposits from a processing chamber.

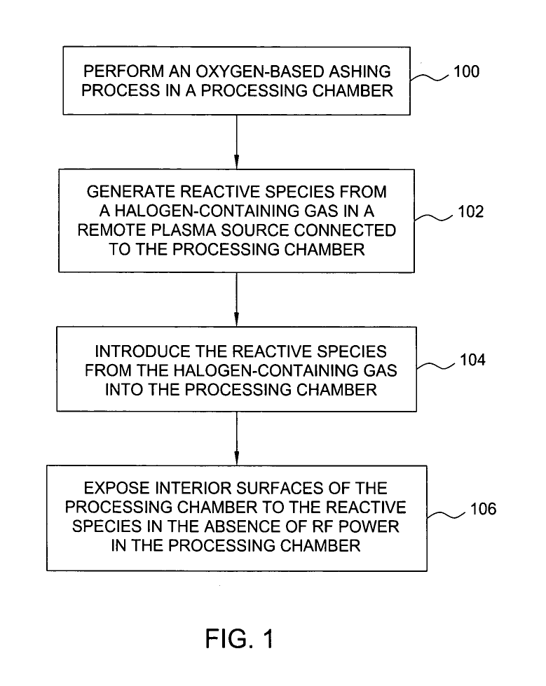

One embodiment of a chamber cleaning method described herein is summarized in FIG. 1 and will be discussed in more detail below. An oxygen-based ashing process is performed in a processing chamber, as shown in step 100. Reactive species are generated in a remote plasma source connected to the processing chamber from a halogen-containing gas, as shown in step 102. The reactive species are introduced into the processing chamber, as shown in step 104. The interior surfaces of the processing chamber are then exposed to the reactive species in the absence of RF power in the chamber, as shown in step 106.

An example of a chamber that may be cleaned using the methods described herein is the PRODUCER® chemical vapor deposition (CVD) chamber, available from Applied Materials, Inc. of Santa Clara, Calif. The PRODUCER® chemical vapor deposition chamber has two isolated processing regions that may be used to deposit carbon-doped silicon oxides, such as low dielectric constant films comprising silicon, oxygen, and carbon, and other materials. A chamber having two isolated processing regions is described in U.S. Pat. No. 5,855,681, which is incorporated by reference herein.

The PRODUCER® chemical vapor deposition chamber has a port to which remote plasma sources may be attached. A PRODUCER® chemical vapor deposition chamber with an Astron®ex remote plasma source available from MKS Instruments may be used in embodiments of the methods described herein. However, other processing chambers and remote plasma sources may be used.

The gas flow rates described below refer to flow rates experienced by the CVD chamber as a whole, i.e., both of the isolated processing regions. Thus, the gas flow rates experienced by each of the processing regions of the CVD chamber are approximately half the gas flow rates experienced by the CVD chamber as a whole. While some examples of embodiments are described with respect to cleaning a processing region of a CVD chamber that has two processing regions, the methods described herein may be used to clean a processing region of a chamber that has one or more than two processing regions.

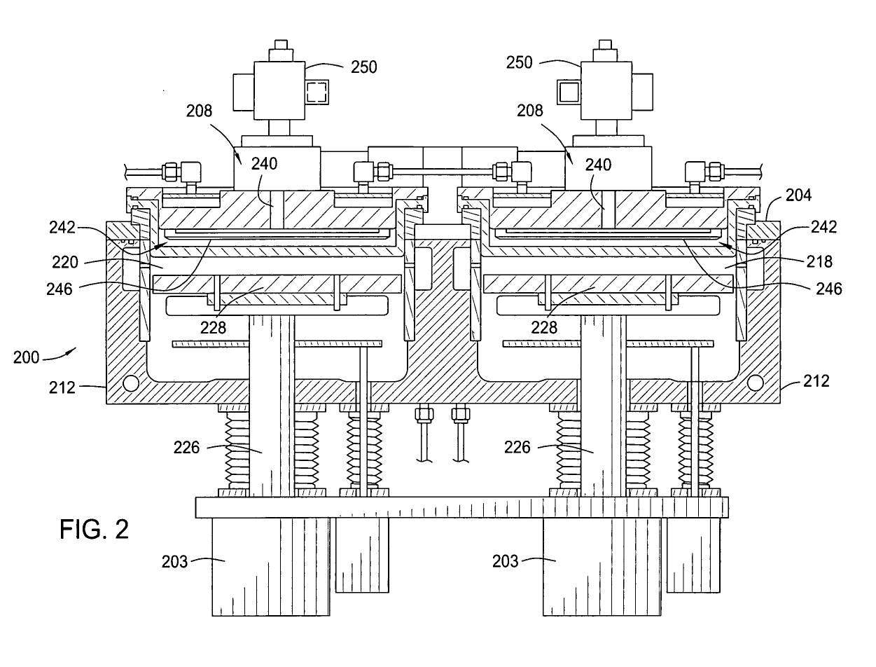

An example of a chamber that has two processing regions and two remote plasma sources is shown in FIG. 2. The chamber 200 has processing regions 218 and 220 inside a chamber body 212 having walls having a heating element(s) (not shown) therein. One remote plasma source 250 is connected to processing region 218, and another remote plasma source 250 is connected to processing region 220. A substrate support 228 that is a heated pedestal is movably disposed in each processing region 218, 220 by a stem 226 which extends through the bottom of the chamber body 212 where it is connected to a drive system 203. Each of the processing regions 218, 220 also preferably includes a gas distribution assembly 208 disposed through the chamber lid 204. The gas distribution assembly 208 of each processing region includes a gas inlet passage 240 which delivers gas into a shower head assembly 242. The shower head assembly 242 includes a face plate 246 to deliver gases into the processing regions 218, 220. The gas distribution assembly 208 includes a heating element(s) (not shown) that heat the components of the gas distribution assembly 208, including the face plate 246.

Returning to FIG. 1, the oxygen-based ashing process includes introducing an oxygen-containing gas into the processing chamber and applying RF power in the processing chamber to provide a plasma for generating reactive oxygen species. The reactive oxygen species may be oxygen radicals, ionized oxygen species, or oxygen species in an excited state. The oxygen-containing gas may be selected from the group consisting of O₂, O₃, CO₂, and combinations thereof, for example. The oxygen-containing gas may be introduced into the processing chamber at a flow rate. The flow rates and other processing conditions provided herein are provided with respect to a chamber used to process a 300 mm substrate and may be adjusted accordingly for other substrate or chamber sizes. Optionally, the oxygen-containing gas may be introduced into the processing chamber with a diluting carrier gas, such as argon, nitrogen, or helium, to enhance plasma stability in the chamber. The oxygen-based ashing process is performed under conditions sufficient to remove carbon deposits previously formed on interior surfaces of the chamber. The rate of the oxygen-based ashing process may be modulated by varying the RF power, spacing, temperature, flow rate of the oxygen-containing gas, and/or the pressure.

After the oxygen-based ashing process is performed in the processing chamber, the RF power in the processing chamber is terminated before the reactive species generated in the remote plasma source are introduced into the chamber, as described in steps 102 and 104 of FIG. 1. Preferably, the reactive species generated in the remote plasma source are introduced into the chamber immediately after the oxygen-based ashing process is completed such that the oxygen-based ashing and the cleaning using the reactive species generated in the remote plasma source are performed “back-to-back.”

The reactive species are generated in the remote plasma source by exposing a halogen-containing gas, such as a fluorine-containing gas or a chlorine-containing gas, to plasma conditions in the remote plasma source. Examples of fluorine-containing gases that may be used include NF₃, CF₄, C₂F₄, C₂F₆, F₂, and combinations thereof. Examples of chlorine-containing gases that may be used include CCl₄, C₂Cl₆, Cl₂, and combinations thereof.

The power provided by the remote plasma source to generate the reactive species may be between about 10 kilowatts, for example. The reactive species may be radicals, ionized species, or species in an excited state. For example, the reactive species may be fluorine radicals, ionized fluorine species, or fluorine species in an excited state. The reactive species may be introduced into the processing chamber from the remote plasma source at a flow rate. The interior surfaces of the processing chamber are exposed to the reactive species for a period of time sufficient to remove silicon and oxygen-containing deposits that may remain on the interior surfaces of the chamber after carbon-containing deposits are removed from the interior surfaces of the chamber by the oxygen-based ashing process.

In preferred embodiments, the oxygen-containing gas used in the oxygen-based ashing process is O₂, and the halogen-containing gas that provides reactive species in the remote plasma source is NF₃.

While the oxygen-based ashing process is shown and described as a single step 100 in the embodiment of FIG. 1, in other embodiments, the oxygen-based ashing process includes two steps. For example, the oxygen-based ashing process may comprise one step to clean primarily the faceplate of the chamber and another step to clean interior surfaces of the chamber other than the faceplate. For example, the oxygen-based ashing process may include cleaning the faceplate at a first pressure and at a first faceplate to substrate support spacing and then cleaning the other interior surfaces of the chamber at a second pressure and at a second faceplate to substrate support spacing. Preferably, the faceplate is cleaned at a higher pressure and a smaller faceplate to substrate support spacing relative to the pressure and spacing used to clean the other interior surfaces of the chamber. Aside from the pressure and spacing, other processing conditions, such as temperature, RF power, and the flow rate of the oxygen-containing gas may be unchanged during the faceplate cleaning and the cleaning of the other interior surfaces of the chamber and may be within the same ranges of conditions described above with respect to the single step oxygen-based ashing process according to the embodiment of FIG. 1.

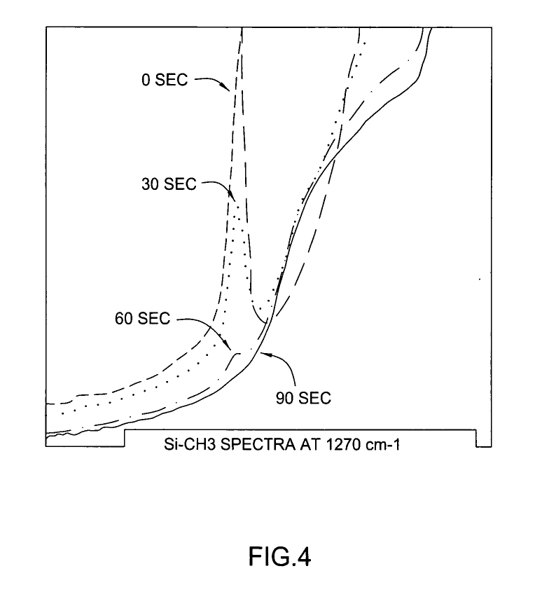

By treating a chamber having silicon, carbon, and oxygen deposits on its interior surfaces with the oxygen-based ashing process provided herein, many of the carbon deposits can be removed since the oxygen-based ashing process oxidizes the carbon deposits, such as to CO₂, which is a gas that can easily be removed from the chamber. FIG. 4 shows FTIR spectra of interior chamber surfaces over the course of an oxygen-based ashing process (after 0, 30, 60, and 90 seconds of ashing) performed according to an embodiment of the invention. The FTIR spectra show that the Si—CH₃ peak diminishes surfaces over the course of the oxygen-based ashing process. Thus, after the oxygen-based ashing process, the remaining deposits are mainly silicon and oxygen-containing deposits that can be removed by using reactive species generated by a remote plasma source only, i.e., without in situ RF power.

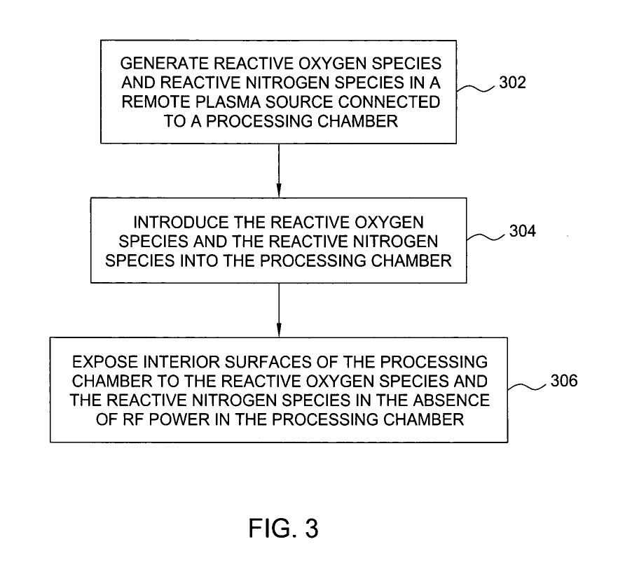

A preferrred embodiment of the invention is summarized in FIG. 3 and will be discussed in more detail below. In the embodiment summarized in FIG. 3, reactive species generated in a remote plasma chamber are used to clean a processing chamber connected to the remote plasma source without the use of RF power in the processing chamber during the cleaning process. As shown in step 302 of FIG. 3, reactive oxygen species and reactive nitrogen species are generated in a remote plasma source connected to a processing chamber. The reactive oxygen species and the reactive nitrogen species are then introduced into the processing chamber, as shown in step 304, and the interior surfaces of the processing chamber are exposed to the reactive oxygen species and the reactive nitrogen species in the absence of RF power in the processing chamber, as shown in step 306, to remove carbon-containing deposits from the processing chamber. Preferably, the reactive oxygen species are generated from O₂. The reactive nitrogen species may be generated from N₂, N₂O, or NO₃, for example.

The reactive oxygen species react with the carbon-containing deposits on the interior surfaces of the chamber to form volatile oxygen and carbon-containing by-products that can easily be removed from the chamber. The reactive nitrogen species promote the dissociation of the oxygen-containing gas that provides the reactive oxygen species. The reactive nitrogen species also assist in the transport of the reactive oxygen species to the chamber and then release the reactive oxygen species in an active form in the processing chamber.

Optionally, reactive fluorine species are also generated in the remote plasma source and introduced into the processing chamber. Reactive fluorine species are useful for removing silicon-containing deposits from the chamber. If the processing chamber is not used to deposit films comprising silicon, for example, a chamber used only to deposit amorphous carbon films, it is preferred to clean the chamber without fluorine reactive species, as the fluorine reactive species may react with the carbon-containing deposits to form fluorocarbon polymers on the chamber surfaces. On the other hand, for a chamber used to deposit both an amorphous carbon film and a SiON dielectric anti-reflective coating (DARC) thereon, it may be desirable to include fluorine reactive species in the cleaning process to remove silicon-containing deposits.

Preferably, an inert gas such as argon, helium, or other inert gases, is also present in the remote plasma source during the generation of the reactive species. The inert gas helps stabilize the pressure in the remote plasma source and assists in transporting the reactive species to the processing chamber. The inert gas may also be dissociated by the remote plasma and aid in the cleaning process. The inert gas may be chosen based on the type of deposits to be removed from the processing chamber. For example, helium may be used as the inert gas for cleaning a processing chamber used to deposit low dielectric constant films comprising silicon, oxygen, carbon, and hydrogen, while argon may be used as the inert gas for cleaning process chambers used to deposit amorphous carbon films or films comprising silicon and carbon, but not oxygen. However, any inert gas can be used for cleaning chambers used to deposit any of the films described herein.

Once the reactive oxygen species, the reactive nitrogen species, and the optional reactive fluorine species are in the processing chamber, the cleaning activity of the reactive species is enhanced by heating the gas distribution assembly, including the faceplate, and the chamber walls to a temperature of at least about 150° C. Heating these surfaces of the chamber accelerates the cleaning process by activating and/or creating additional reactive species in the chamber. In one aspect, the chamber surfaces are heated by continuing or maintaining the heat that is typically applied to these surfaces during the deposition of a film on a substrate in the chamber after the deposition is completed and throughout the cleaning process.

The remote plasma-based cleaning processes described herein have several advantages over cleaning processes that use in situ RF power that provides a plasma inside a chamber. For example, damage to chamber components such as the faceplate is minimized since the plasma is provided remotely rather than in situ. The formation of aluminum fluoride particles on the faceplate is also minimized by providing the plasma remotely rather than in situ. The reactive species provided by the remote plasma source can reach regions of the chamber, such as a chamber slit valve or substrate passageway, the exhaust port, and the chamber bottom, that are difficult to clean with in situ RF power, as they are not in the plasma processing region of the chamber. Furthermore, the remote plasma-based cleaning processes described herein can provide higher etch rates than in situ oxygen plasma-based cleaning processes which can result in plasma densification of the residues or deposits on the chamber surfaces. Plasma densified residues are harder and more difficult to etch, and thus slow down the cleaning process.

In order to further enhance the cleaning of the bottom of the chamber, reactive species from the remote plasma source may be introduced into bottom of the chamber through a divert line that runs from the remote plasma source into the bottom of the chamber such that some of the reactive species are introduced into the chamber without first passing through the gas distribution assembly of the chamber.

Cleaning Chambers Used to Deposit Films Comprising Silicon and Carbon

The chamber cleaning methods provided herein are particularly useful for cleaning chambers that have been used to deposit and/or post-treat films comprising silicon and carbon, such as silicon and carbon-containing barrier films and low dielectric constant films (e.g., k<2.5) comprising silicon, carbon, oxygen, and hydrogen. For example, the low dielectric constant films may be deposited by plasma-enhanced chemical vapor deposition from a deposition gas mixture including an organosilicon compound and a hydrocarbon-based compound. As defined herein, a hydrocarbon-based compound includes hydrocarbons that include only carbon and hydrogen as well as compounds that include primarily carbon and hydrogen, but also include other atoms, such as oxygen or nitrogen. The deposition gas mixture may also include other components, such as an oxidizing gas and multiple organosilicon compounds. Post-treatments that may be used to modify the film's properties, such as to increase porosity and to improve mechanical properties, include plasma, UV, and electron beam treatments. Methods of depositing such low dielectric constant films are described in commonly assigned U.S. Pat. No. 6,936,551 and U.S. Patent Publication No. 2004/0101633, which are herein incorporated by reference.

Processing conditions for cleaning chambers used to deposit films comprising silicon and carbon and optionally oxygen by a cleaning process as summarized in FIG. 3 will now be provided. The reactive oxygen species and the reactive fluorine species may be radicals, ionized species, or species in an excited state. The reactive oxygen species are generated from an oxygen-containing gas, such as O₂, O₃, CO₂, and combinations thereof. The reactive fluorine species are generated from a fluorine-containing gas, such as NF₃, CF₄, C₂F₄, C₂F₆, F₂, and combinations thereof. In a preferred embodiment, the reactive oxygen species are generated from O₂, and the reactive fluorine species are generated from NF₃. The reactive oxygen species may be introduced into the processing chamber from the remote plasma source at a first flow rate, and the reactive fluorine species may be introduced into the processing chamber from the remote plasma source at a second flow rate. Preferably, the reactive oxygen species are generated from O₂, and the reactive fluorine species are generated from NF₃.

It was found that the ratio of the flow rate of the reactive species generated from NF₃ to the flow rate of the reactive species generated from O₂ (abbreviated herein as the NF₃:O₂ ratio) is a key variable for controlling the etch rate of the cleaning process. Optimally, the NF₃:O₂ ratio is about 0.083 (1:12). It was also found that while most of the silicon can be removed from residues on the chamber surfaces at higher NF₃:O₂ ratios, loose, solid carbon and fluorine-containing residues remained after chamber cleaning processes performed at higher NF₃:O₂ ratios.

Optionally, a carrier or diluting gas, such as argon or helium, may be used to assist in the transport of the reactive species from the remote plasma source to the processing chamber.

The interior surfaces of the processing chamber are exposed to the reactive species for a period of time sufficient to remove silicon and carbon-containing deposits previously formed on the interior surfaces of the processing chamber during a deposition of a silicon and carbon-containing film, such as a low dielectric constant film deposited from a mixture comprising an organosilicon compound and a hydrocarbon-based compound in the processing chamber.

During the exposure of the interior surfaces of the chamber to the reactive species, the chamber pressure may be between about 1 Torr and about 2.8 Torr. Higher chamber pressures resulted in lower etch rates. It is believed that the higher pressures accelerate recombination of the reactive species into less active species, e.g., fluorine radicals may be recombined to form F₂, while lower pressures enhance the transport of the reactive species to regions of the chamber that are difficult to clean.

It is believed that the exposure of both NF₃ and O₂ to plasma conditions in the remote plasma source generates OF radicals which can dissociate to oxygen and fluorine radicals that react with carbon and hydrogen-containing residues in the chamber to form CO and HF volatile by-products that can be easily removed from the chamber. Cleaning processes that were performed using process conditions similar to those provided herein with the exception that the O₂ was provided to the processing chamber downstream of the remote plasma source rather than from within the remote plasma source had significantly lower etch rates than cleaning processes in which both the NF₃ and O₂ were exposed to plasma conditions in the remote plasma source before being introduced into the processing chamber.

A lack of excited and, potentially, reactive species of NF₃ and O₂ when O₂ is provided to the processing chamber downstream of the remote plasma source is demonstrated by the absence of luminescence of the afterglow in the plasma. Luminescence of the afterglow normally occurs when both the NF₃ and O₂ are exposed to plasma conditions in the remote plasma source before being introduced into the processing chamber. Thus, the observed luminescence of the NF₃ and O₂ plasma afterglow can be used to monitor cleaning rate conditions in the process chamber in addition to using the afterglow as an endpoint indicator for the cleaning process. In one embodiment, the intensity of the NF₃ and O₂ plasma afterglow luminescence may be measured by conventional luminometers known in the art. Higher measured intensity values indicate higher concentrations of excited species of NF₃ and O₂ in the plasma. Thus, the measured intensity values can be used as an indicator of how changing process parameters such as flow rates, temperatures, and RF powers affects the formation of excited species of NF₃ and O₂ in the plasma, and thus also the cleaning rate conditions. An increase in the luminescence intensity values during a cleaning process may also be used as an endpoint indicator for the cleaning process. As the cleaning process is initiated, excited species of NF₃ and O₂ in the plasma react with carbon and hydrogen-containing residues in the chamber. Upon removal of the carbon and hydrogen-containing residues the concentration of excited species of NF₃ and O₂ may increase as less of the excited species react with the carbon and hydrogen-containing residues.

Preferably, the interior surfaces of the chamber are heated to a temperature of at least about 150° C. during the exposure of the interior surfaces of the chamber to the reactive species. The interior surfaces may be heated by a heated substrate support in the chamber and a heated gas distribution assembly. Heating the interior surfaces of the chamber accelerates the cleaning process by activating and/or creating additional reactive species in the chamber. For example, the relatively inactive cleaning gas O₃ will dissociate and provide reactive oxygen species on surfaces heated to at least about 150° C. Heating the faceplate of the gas distribution assembly particularly accelerates the cleaning process since a clean faceplate allows more of the reactive species into the rest of the chamber.

Cleaning Chambers Used to Deposit Amorphous Carbon Films

As discussed above, a processing chamber used to deposit amorphous carbon films may be cleaned by exposing the interior surfaces of the processing chamber to reactive oxygen species and reactive nitrogen species generated by a remote plasma source in the absence of reactive fluorine species, i.e., without reactive fluorine species provided by the remote plasma source or generated by introducing a fluorine source and applying power in the chamber. Also, as discussed above, the interior surfaces of the chamber are heated at a temperature, such as at a temperature of at least about 150° C.

The processing chamber used to deposit the amorphous carbon films may be a PRODUCER® or PRODUCER® SE chamber, both of which are available from Applied Materials, Inc. The remote plasma source may be an Astron®ex remote plasma source available from MKS Instruments. However, other processing chambers and remote plasma sources may be used.

The power provided by the remote plasma source to generate the reactive species may be up to 10 kW. The reactive oxygen species may be introduced into the processing chamber from the remote plasma source at a first flow rate, and the reactive nitrogen species may be introduced into the processing chamber from the remote plasma source at a second flow rate. Preferably, the reactive oxygen species are generated from O₂.

Optionally, a carrier or diluting gas, such as argon or helium, may be used to assist in the transport of the reactive species from the remote plasma source to the processing chamber.

During the exposure of the interior surfaces of the chamber to the reactive species, the chamber pressure may be between about 1 Torr and about 2 Torr.

According to another aspect of the invention, a cleaning process comprising generating reactive oxygen species from an oxygen-containing gas and reactive fluorine species from a fluorine-containing gas in a remote plasma source connected to a processing chamber, introducing the reactive oxygen species and the reactive fluorine species into the processing chamber, and exposing interior surfaces of the processing chamber to the reactive oxygen species and the reactive fluorine species in the absence of RF power in the chamber is used to clean a processing chamber used to deposit amorphous carbon films. In particular, such a cleaning process is useful for removing deposits previously formed on the interior surfaces of the processing chamber during a deposition of an amorphous carbon film from an aromatic precursor, such as toluene, or other cyclic, unsaturated hydrocarbons, in a plasma enhanced chemical vapor deposition (PECVD) reaction. Deposits formed during the deposition of an amorphous carbon film from such precursors often include large, polymeric carbon-containing residues that are more difficult to remove than deposits formed during the deposition of amorphous carbon films from short chain, linear hydrocarbons, such as propylene or acetylene. It is noted that the cleaning process provided herein for cleaning a chamber used to deposit an amorphous carbon film from an aromatic precursor, such as toluene, or other cyclic, unsaturated hydrocarbons may also be used to clean a chamber used to deposit an amorphous carbon film from other hydrocarbon compounds, such as short chain, linear hydrocarbons, such as propylene or acetylene.

The processing chamber used to deposit the amorphous carbon films may be a PRODUCER® or PRODUCER® SE chamber, both of which are available from Applied Materials, Inc. The remote plasma source may be an Astron®ex remote plasma source available from MKS Instruments. However, other processing chambers and remote plasma sources may be used.

The power provided by the remote plasma source to generate the reactive species may be up to 10 kW. The reactive oxygen species may be introduced into the processing chamber from the remote plasma source at a flow rate between about 1000 sccm and about 4000 sccm. The reactive fluorine species may be introduced into the processing chamber from the remote plasma source at a flow rate between about 50 sccm and about 500 sccm. Preferably, the reactive oxygen species are generated from O₂, and the reactive fluorine species are generated from NF₃. It was found that the ratio of the flow rate of the reactive species generated from NF₃ to the flow rate of the reactive species generated from O₂ (abbreviated herein as the NF₃:O₂ ratio) is a key variable for controlling the etch rate of the cleaning process. Preferably, the NF₃:O₂ ratio is between about 0.1 (1:10) and about 0.3, as both higher and lower ratios resulted in lower etch rates. Optimally, the NF₃:O₂ ratio is about 0.1.

Optionally, a carrier or diluting gas, such as argon or helium, may be used to assist in the transport of the reactive species from the remote plasma source to the processing chamber. The flow rate of the carrier or diluting gas into the processing chamber may be between about 0 sccm and about 3000 sccm or even up to 9000 sccm. Comparable etch rates were obtained with cleaning processes using argon as a carrier or diluting gas and with cleaning processes using helium as a carrier or diluting gas. The optimal NF₃:O₂ ratio is 0.1 for both cleaning processes. A slightly higher etch rate was observed when helium was used as a carrier or diluting gas rather than argon at an NF₃:O₂ ratio of 0.1.

The total flow rate of the NF₃, O₂, and optional carrier gas may be between about 2000 sccm and about 6000 sccm. Higher etch rates were obtained at higher total flow rates.

During the exposure of the interior surfaces of the chamber to the reactive species, the chamber pressure may be between about 1 Torr and about 2 Torr. A significant drop in etch rate was observed at chamber pressures above about 2 Torr.

The temperature of the substrate support may be set to between about 300° C. and about 400° C. Preferably, the gas distribution assembly may be heated to a temperature of about 160° C. such that the faceplate has a temperature of approximately 160° C. However, the gas distribution assembly may also be heated to lower temperatures, such as between about 75° C. and about 160° C. It was found that etch rates increased at higher gas distribution assembly heater temperatures. However, a satisfactory etch rate of greater than 8000 Å/minute was observed at a heater temperature of 75° C.

The spacing between the substrate support and the faceplate of the gas distribution assembly of the chamber may be between about 200 mils and about 1000 mils.

The interior surfaces of the processing chamber are exposed to the reactive species for a period of time sufficient to remove silicon and oxygen-containing deposits from the interior surfaces of the chamber. For example, the interior surfaces of the processing chamber may be exposed to the reactive species for about 35 seconds per 1000 Å thickness of deposits.

An example of an embodiment will now be described.

### EXAMPLE 1

A PRODUCER® CVD chamber was cleaned by generating reactive oxygen species and reactive fluorine species in an Astron®ex remote plasma source and introducing the reactive oxygen species and reactive fluorine species into the PRODUCER® CVD chamber and exposing the interior surfaces of the chamber to the reactive species for about 150 seconds in the absence of RF power in the chamber to remove about 6000 Å of a low dielectric constant film comprising silicon, oxygen, and carbon. The low dielectric constant film had been previously deposited in the chamber in a PECVD process from a gas mixture comprising methyldiethoxysilane (mDEOS), norbornadiene (BCHD), and oxygen. The reactive oxygen species were introduced into the chamber from the remote plasma source at a flow rate of about 6000 sccm. The reactive fluorine species were introduced into the chamber from the remote plasma source at a flow rate of about 500 sccm. Helium was used as a carrier gas and was flowed into the chamber at a rate of about 6000 sccm. During the exposure of the interior surfaces of the chamber to the reactive species, the chamber pressure was about 2.8 Torr. The gas distribution assembly including the faceplate and the chamber walls were heated during the exposure of the interior surfaces to the reactive species. The faceplate to substrate support spacing was about 1800 mils.

While the foregoing is directed to embodiments of the present invention, other and further embodiments of the invention may be devised without departing from the basic scope thereof, and the scope thereof is determined by the claims that follow.

What is claimed is:

1. A method of cleaning a processing chamber comprising chamber walls and a gas distribution assembly having a faceplate, comprising:
generating reactive oxygen species from an oxygen-containing gas in a remote plasma source connected to the processing chamber;
generating reactive nitrogen species from a nitrogen-containing gas in the remote plasma source;
introducing the reactive oxygen species and the reactive nitrogen species into the processing chamber; and
exposing interior surfaces of the processing chamber to the reactive oxygen species and the reactive nitrogen species in the absence of RF power in the chamber while the gas distribution assembly and the chamber walls are heated, wherein the exposing the interior surfaces to the reactive oxygen species and the reactive nitrogen species removes carbon-containing deposits previously formed on the interior surfaces of the processing chamber during a deposition of an amorphous carbon film in the processing chamber.

2. The method of claim 1, wherein the interior surfaces are exposed to the reactive oxygen species and the reactive nitrogen species without exposing the interior surfaces to reactive fluorine species.

3. The method of claim 1, wherein the reactive oxygen species are generated from O₂ and the reactive nitrogen species are generated from NF₃.

4. The method of claim 3, wherein the ratio of a flow rate of the reactive species generated from NF₃ into the processing chamber to a flow rate of the reactive species generated from O₂ into the processing chamber is between about 0.1 and about 0.3.

5. The method of claim 4, wherein the interior surfaces of the processing chamber are exposed to the reactive oxygen species and the reactive nitrogen species at a chamber pressure between about 1 Torr and about 2 Torr.

6. The method of claim 1, wherein the amorphous carbon film is deposited by a PECVD process from a gas mixture comprising toluene.

7. The method of claim 1, further comprising measuring a luminescence of an afterglow of the reactive oxygen species and the reactive nitrogen species in the processing chamber.

8. A method of cleaning a processing chamber comprising chamber walls and a gas distribution assembly having a faceplate, comprising:
generating reactive oxygen species from an oxygen-containing gas in a remote plasma source connected to the processing chamber;
generating reactive fluorine species from a fluorine-containing gas in the remote plasma source;
introducing the reactive oxygen species and the reactive fluorine species into the processing chamber; and
exposing interior surfaces of the processing chamber to the reactive oxygen species and the reactive fluorine species in the absence of RF power in the chamber while the gas distribution assembly and the chamber walls are heated, wherein the exposing the interior surfaces to the reactive oxygen species and the reactive fluorine species removes silicon and carbon-containing deposits previously formed on the interior surfaces of the processing chamber.

9. The method of claim 8, wherein the reactive oxygen species are generated from O₂ and the reactive fluorine species are generated from NF₃.

10. The method of claim 9, wherein the ratio of a flow rate of the reactive species generated from NF₃ into the processing chamber to a flow rate of the reactive species generated from O₂ into the processing chamber is about 1:12.

11. The method of claim 10, wherein the interior surfaces of the processing chamber are exposed to the reactive oxygen species and the reactive fluorine species at a chamber pressure between about 1 Torr and about 2.8 Torr.

12. The method of claim 8, wherein the silicon and carbon-containing deposits were formed during a deposition of a low dielectric constant film from a mixture comprising an organosilicon compound and a hydrocarbon-based compound in the processing chamber.

13. The method of claim 8, further comprising measuring a luminescence of an afterglow of the reactive oxygen species and the reactive nitrogen species in the processing chamber.

14. A method of cleaning a processing chamber, comprising:
performing an oxygen-based ashing in the processing chamber;
generating reactive species from a halogen-containing gas in a remote plasma source connected to the processing chamber; and
exposing interior surfaces of the processing chamber to the reactive species in the absence of RF power in the processing chamber.

15. The method of claim 14, wherein the oxygen-based ashing comprises introducing an oxygen-containing gas into the processing chamber and applying RF power in the processing chamber to generate reactive oxygen species, and the RF power is terminated before the exposing interior surfaces of the processing chamber to the reactive species from the halogen-containing gas.

16. The method of claim 15, wherein the oxygen-based ashing comprises introducing O₂ into the processing chamber, and the halogen-containing gas is NF₃.

17. The method of claim 14, wherein the processing chamber comprises a faceplate and a substrate support, and the oxygen-based ashing comprises cleaning the faceplate at a first pressure and a first faceplate to substrate support spacing and cleaning other surfaces of the processing chamber at a second pressure and a second faceplate to substrate support spacing.

18. The method of claim 14, wherein the halogen-containing gas is fluorine-containing gas or a chlorine-containing gas.

19. The method of claim 14, wherein the oxygen-based ashing and the exposing interior surfaces of the processing chamber to the reactive species remove silicon, carbon, and oxygen deposits previously formed on the interior surfaces of the processing chamber during a deposition of a low dielectric constant film from a mixture comprising a organosilicon compound and a hydrocarbon-based compound in the processing chamber.

20. The method of claim 14, further comprising measuring a luminescence of an afterglow of the reactive oxygen species and the reactive nitrogen species in the processing chamber.
